(19) United States
(12) Patent Application Publication
(10) Pub. No.: US 2025/0269540 A1
(43) Pub. Date: Aug. 28, 2025

(54) OPTICAL TACTILE SENSOR, ROBOT HAND, AND ROBOT ARM

(71) Applicant: TACLE INC., Nagoya-shi (JP)

(72) Inventors: Goro OBINATA, Nagoya-shi (JP); Hiroyuki NISHIMURA, Anjo-shi (JP); Kazuyasu NAKANE, Anjo-shi (JP)

(73) Assignee: TACLE INC., Nagoya-shi (JP)

(21) Appl. No.: 19/209,093

(22) Filed: May 15, 2025

Related U.S. Application Data
(63) Continuation of application No. PCT/JP2023/042603, filed on Nov. 28, 2023.

(30) Foreign Application Priority Data
Nov. 28, 2022 (JP) 2022-189126
Nov. 21, 2023 (JP) 2023-197501

(51) Int. Cl. B25J 13/08; G01B 11/16

(52) U.S. Cl. CPC B25J 13/084; G01B 11/16

(57) ABSTRACT

An optical tactile sensor comprising a contact part having a contact surface that comes into contact with an object, the contact part being deformed in response to a contact state of the object with respect to the contact surface; a marker disposed on the contact part, and configured to be displaced in response to deformation of the contact part; and an imaging unit configured to capture an image of the marker from a side opposite to a side where the object comes into contact, wherein the contact part allows light in a first wavelength range to pass therethrough, and blocks light in a second wavelength range different from the first wavelength range, the marker reflects light that is incident on the marker from the opposite side, and the imaging unit receives the light reflected by the marker and the light in the first wavelength range, and generates an image.

### CROSS REFERENCE TO RELATED APPLICATION

This application is a Continuation of International Application No. PCT/JP2023/042603, filed on Nov. 28, 2023, which claims the benefit of Japanese Patent Application Number 2022-189126 filed on Nov. 28, 2022, and Japanese Patent Application Number 2023-197501 filed on Nov. 21, 2023, the disclosures of which are incorporated by reference herein in their entireties.

### FIELD OF THE INVENTION

The present disclosure relates to an optical tactile sensor, a robot hand, and a robot arm.

### BACKGROUND OF THE INVENTION

International Publication No. WO2005/085785 discloses an example of an optical tactile sensor. This optical tactile sensor includes a tactile part and an imaging means. The tactile part is made of a light-transmitting elastic body having a convex curved surface, and a marker is disposed on the convex curved surface. The imaging means captures an image of a behavior of the marker when an object comes into contact with the convex curved surface.

### SUMMARY OF THE INVENTION

In the optical tactile sensor disclosed in WO 2005/085785 A1, the tactile part is made of a light-transmitting elastic body having a convex curved surface and does not have a light blocking function. Therefore, external light enters the imaging means through the tactile part from the space on the object side in contact with the tactile part, and the captured image generated by the imaging means is likely to be affected by the external light.

Meanwhile, JP 2012-42220 A discloses a shape measuring apparatus including a film that is deformable according to the shape of an object. This shape measuring apparatus includes a film that blocks light, and therefore prevents external light from entering an imaging means through the film from the space on the object side.

However, since the film blocks light, the imaging means cannot capture an image of the space on the object side, and the state of the space on the object side cannot be expressed in a captured image.

The present disclosure has been made in view of the aforementioned circumstances. The present disclosure relates to an optical tactile sensor that captures an image of a marker disposed on a contact part, from a side opposite to the side where an object comes into contact, and provides a technique capable of preventing entry of light in a certain wavelength range from the space on the object side, and capturing an image of the space on the object side by utilizing light in another wavelength range.

An optical tactile sensor according to one aspect of the present disclosure includes:

a contact part having a contact surface that comes into contact with an object, the contact part being deformed in response to a contact state of the object with respect to the contact surface;

a marker disposed on the contact part, and configured to be displaced in response to deformation of the contact part; and

an imaging unit configured to capture an image of the marker from a side opposite to a side where the object comes into contact, wherein

the contact part allows light in a first wavelength range to pass therethrough, and blocks light in a second wavelength range different from the first wavelength range,

the marker reflects light that is incident on the marker from the opposite side, and

the imaging unit receives the light reflected by the marker and the light in the first wavelength range, and generates an image.

The technique according to the present disclosure relates to an optical tactile sensor that captures an image of a marker disposed on a contact part, from a side opposite to the side where an object comes into contact. The optical tactile sensor can prevent entry of light in a certain wavelength range, from a space on the object side, and capture an image of the space on the object side by utilizing light in another wavelength range.

### BRIEF DESCRIPTION OF THE DRAWINGS

FIG. 1 is a diagram schematically illustrating an optical tactile sensor according to a first embodiment.

FIG. 2 is a diagram schematically illustrating a shape measurement system including the optical tactile sensor shown in FIG. 1.

FIG. 3 is a schematic cross-sectional view illustrating a configuration of a touch pad and its vicinity in the optical tactile sensor shown in FIG. 1.

FIG. 4 is a diagram conceptually illustrating a configuration in which the touch pad and its vicinity in the optical tactile sensor shown in FIG. 1. FIG. 4 is viewed from a side where an imaging unit exists.

FIG. 5 is a perspective view schematically illustrating a touch pad of an optical tactile sensor according to a third embodiment.

FIG. 6 is a perspective view in which the touch pad shown in FIG. 5 is viewed in a direction different from FIG. 5.

FIG. 7 is a plan view in which the touch pad shown in FIG. 5 is viewed from the imaging unit side.

FIG. 8 is a cross-sectional view taken along a line A-A in FIG. 7.

FIG. 9 is a perspective view schematically illustrating a touch pad of an optical tactile sensor according to a fourth embodiment.

FIG. 10 is a perspective view in which the touch pad shown in FIG. 9 is viewed in a direction different from FIG. 9.

FIG. 11 is a plan view in which the touch pad shown in FIG. 9 is viewed from the imaging unit side.

FIG. 12 is a cross-sectional view taken along a line B-B shown in FIG. 11.

### DETAILED DESCRIPTION OF THE INVENTION

Hereinafter, a preferred example of the present disclosure will be described.
[1] An optical tactile sensor including:

a contact part having a contact surface that comes into contact with an object, the contact part being deformed in response to a contact state of the object with respect to the contact surface;

a marker disposed on the contact part, and configured to be displaced in response to deformation of the contact part; and

an imaging unit configured to capture an image of the marker from an opposite side that is a side opposite to a side where the object comes into contact, wherein

the contact part allows light in a first wavelength range to pass therethrough, and blocks light in a second wavelength range different from the first wavelength range,

the marker reflects light that is incident on the marker from the opposite side, and

the imaging unit receives the light reflected by the marker and the light in the first wavelength range, and generates an image.
[2] The optical tactile sensor according to the above [1], wherein the first wavelength range includes at least a portion of a wavelength range of infrared light or ultraviolet light, and

the second wavelength range includes at least a portion of a wavelength range of visible light.
[3] The optical tactile sensor according to the above [1] or [2], including an irradiation unit configured to irradiate the contact part with illumination light including the light of the first wavelength range from the opposite side.
[4] The optical tactile sensor according to any one of the above [1] to [3], including an image generation unit configured to generate an image in which influence of a part of light is reduced or removed, based on image information generated by the imaging unit.
[5] The optical tactile sensor according to the above [4], wherein the part of light is light in the first wavelength range.
[6] The optical tactile sensor according to the above [4], wherein the part of light is light in a wavelength range other than the first wavelength range.
[7] The optical tactile sensor according to any one of the above [1] to [6], wherein

the contact part has a film shape, and

the marker includes a plurality of projections that project from a back surface, of the contact part, opposite to the contact surface.
[8] An optical tactile sensor including:

a contact part having a contact surface that comes into contact with an object, the contact part being deformed in response to a contact state of the object with respect to the contact surface;

a marker disposed on the contact part, and configured to be displaced in response to deformation of the contact part; and

an imaging unit configured to capture an image of the marker from a side opposite to a side where the object comes into contact, wherein

the contact part has a film shape, and

the marker includes a plurality of projections that project from a back surface, of the contact part, opposite to the contact surface.
[9] The optical tactile sensor according to the above [8], wherein the projections project in a normal direction from the back surface.
[10] The optical tactile sensor according to the above [8] or [9], wherein the projections project in an imaging direction of the imaging unit.
[11] The optical tactile sensor according to any one of the above [8] to [10], wherein the contact surface is a curved surface projecting to the side where the object comes into contact.
[12] The optical tactile sensor according to any one of the above [8] to [10], wherein the contact surface is a flat surface.
[13] The optical tactile sensor according to any one of the above [8] to [12], wherein a tip marker, which is different in at least one of hue, brightness, and saturation from the back surface, is disposed at a tip of each projection.
[14] The optical tactile sensor according to the above [13], wherein an intermediate part, which is different in at least one of hue, brightness, and saturation from the tip marker of each projection, is provided between the tip marker and the back surface of the contact part.
[15] A shape measurement system including:

the optical tactile sensor according to any one of the above [1] to [14]; and

a shape measurement unit configured to analyze the image generated by the imaging unit, and measure the shape of the object.
[16] A sensing method using the optical tactile sensor according to any one of the above [1] to [14], the method including:

the contact part allowing light in a first wavelength range to pass therethrough, and blocking light in a second wavelength range different from the first wavelength range;

the marker reflecting light that is incident on the marker from the opposite side, and

the imaging unit receiving the light reflected by the marker and the light in the first wavelength range, and generating an image.
[17] A shape measurement method using the sensing method according to the above [16], the method including analyzing an image generated by the imaging unit to obtain the shape of the object.
[18] A robot hand including the optical tactile sensor according to any one of the above [1] to [14].
[19] A robot arm including the optical tactile sensor according to any one of the above [1] to [14].

### First Embodiment

1. Optical Tactile Sensor 1

The following description relates to an optical tactile sensor according to a first embodiment, a shape measurement system including the optical tactile sensor, a sensing method using the optical tactile sensor, a shape measurement method using the sensing method, a robot hand including the optical tactile sensor, and a robot arm including the optical tactile sensor.

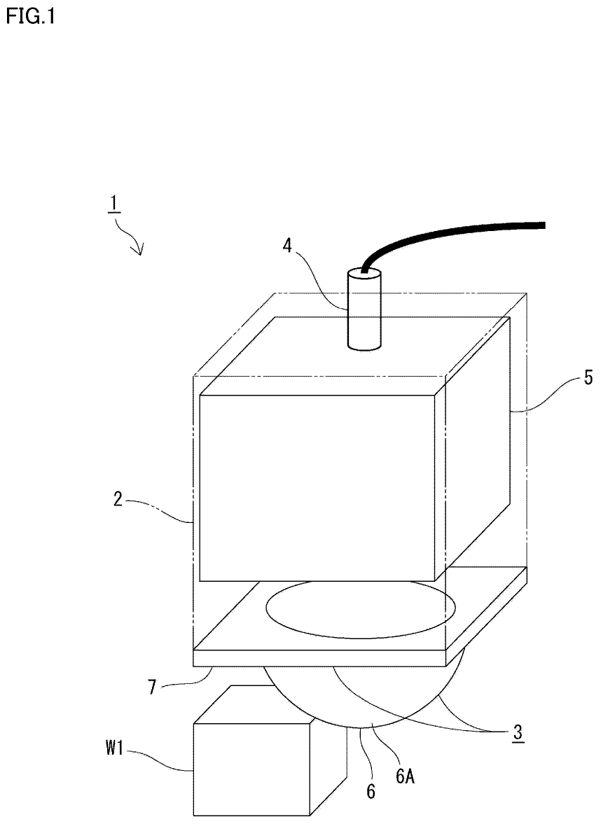

FIG. 1 shows an optical tactile sensor 1 according to the first embodiment. The optical tactile sensor 1 is a sensor for sensing an object W1. The optical tactile sensor 1 is applicable to a robot hand or a robot arm that comes into contact with the object W1 or holds the object W1. FIG. 1 shows an example of the object W1, but the shape and size of the object W1 are not limited to the example in FIG. 1, and objects of various shapes can be targeted.

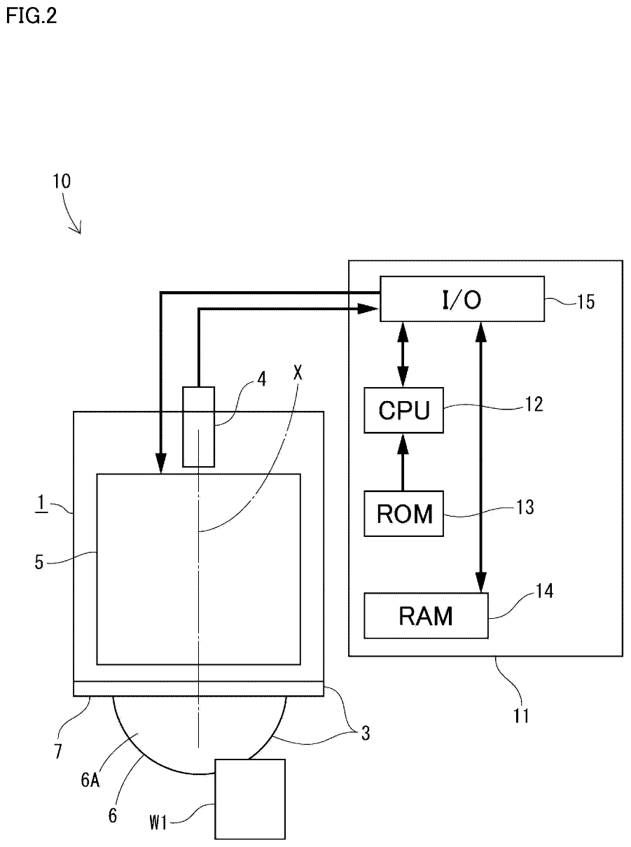

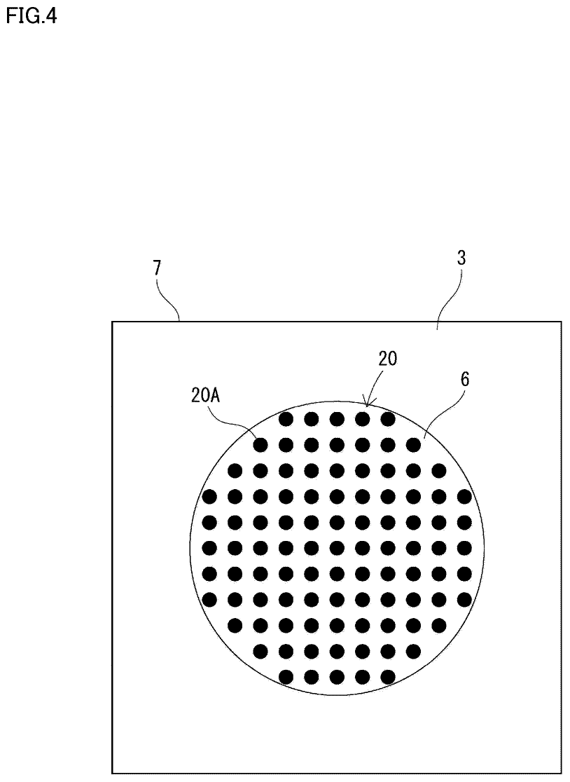

The optical tactile sensor 1 includes at least of a case 2, a touch pad 3, an imaging unit 4, and an irradiation unit 5. The optical tactile sensor 1 may be a constituent of a shape measurement system 10 as shown in FIG. 2, for example. The touch pad 3 has at least of a contact part 6, and a marker 20 (FIG. 4).

In this specification, a direction parallel to an optical axis X of the imaging unit 4 shown in FIG. 2 is an example of an imaging direction. In FIG. 2, the optical axis X of the imaging unit 4 is conceptually shown by a dashed-and-dotted line. In this specification, the direction parallel to the optical axis X is also referred to as an up-down direction. In this specification, in the up-down direction, the side on which the imaging unit 4 is disposed is the upper side, and the side on which the contact part 6 is disposed is the lower side.

The imaging unit 4 shown in FIG. 1 is, for example, an imaging device such as a CCD camera or a CMOS camera. In a typical example, the imaging unit 4 can receive light in at least a visible light region and generate a captured image. For example, the imaging unit 4 can receive light in the visible light region and light in a region (e.g., first wavelength range) outside the visible light region, and generate a captured image. The imaging unit 4 is configured as a color camera in which an R element that generates red shading information of incident light, a G element that generates green shading information of incident light, and a B element that generates blue shading information of incident light are arranged in a light receiving region. For example, RGB elements in which an R element, a G element, and a B element are combined in a predetermined arrangement are arrayed in the light receiving region. The aforementioned imaging device is just an example, and any known camera may be used as long as the camera can capture images of R, G, B components.

The imaging unit 4 is disposed on the side opposite to the “side where the object W1 comes into contact” with the contact part 6. The imaging unit 4 captures an image of the marker 20 from the “side opposite to the side where the object W1 comes into contact”. The “side where the object W1 comes into contact” is, specifically, the side on a space, facing a contact surface 6A, of two spaces partitioned by the contact part 6, in other words, the side on the space where the object W1 is present. The “side opposite to the side where the object W1 comes into contact” is the side on a space, facing a rear surface 6B, of the two spaces partitioned by the contact part 6, in other words, the side on the space where the object W1 is not present. In the example shown in FIG. 1, the “side where the object W1 comes into contact” is the lower side of the contact part 6, and the “side opposite to the side where the object W1 comes into contact” is the upper side of the contact part 6. That is, the imaging unit 4 captures an image of the marker 20 from the upper side with respect to the contact part 6. Then, the imaging unit 4 can receive reflected light from the marker 20 and light in the first wavelength range described later, and generate an image.

The irradiation unit 5 shown in FIG. 1 emits illumination light including light in the first wavelength range described later. The arrangement and size of the irradiation unit 5 may be configured such that a plurality of markers 20 can be irradiated with the illumination light. As the irradiation unit 5, for example, a coaxial epi-illumination may be adopted, or another illumination device may be adopted. In a typical example, the irradiation unit 5 is configured to emit both visible light and light in the first wavelength range. In this case, the center frequency is not particularly limited, and may be within the wavelength range of visible light, or may be within the first wavelength range. The irradiation unit 5 may be a single illumination device capable of emitting both visible light and light in the first wavelength range. Alternatively, as the irradiation unit 5, an illumination device that emits visible light and an illumination device that emits light in the first wavelength range may be separately provided. In a typical example of the present embodiment, the first wavelength range is a range including at least a part of the wavelength range of infrared light, and the irradiation unit 5 is an infrared irradiation device that emits infrared light. In the typical example, the irradiation unit 5 is composed of, for example, one type of LED, illumination light emitted from the irradiation unit 5 includes visible light and infrared light, the center frequency of the illumination light emitted from the irradiation unit 5 is within the wavelength range of infrared light, and the infrared light included in the illumination light is reliably transmitted through the contact part 6. However, the irradiation unit is not limited to this example. As the irradiation unit, a unit that emits visible light (e.g., visible LED) and a unit that emits light in the wavelength range of infrared light (e.g., infrared LED) may be separately provided.

In the example shown in FIG. 1, the irradiation unit 5 and a part of the imaging unit 4 are housed in the box-like case 2. In FIG. 1, the case 2 is conceptually shown by a dashed-and-double-dotted line. The space inside the case 2 is closed at the top by an upper wall of the case 2, is closed at the bottom by the touch pad 3, and is covered on the periphery by a peripheral wall of the case 2. In the example shown in FIG. 1, the case 2 is formed in a box shape having an open bottom end, and the touch pad 3 is fixed so as to close the bottom end of the case 2. For example, the case 2 is made of a material that blocks transmission of light, and light is blocked by the upper wall and the peripheral wall of the case 2.

The touch pad 3 shown in FIG. 1 is a part for sensing the object W1, and is a part on which the object W1 is abutted from the space outside the optical tactile sensor 1. The touch pad 3 has a contact part 6 that is deformed when the object W1 comes into contact with it, and a peripheral part 7 disposed around the contact part 6. The contact part 6 is configured to be elastically deformable, for example. The peripheral part 7 forms a part, of the touch pad 3, on an outer edge side relative to the contact part 6. In the example shown in FIG. 1, the peripheral part 7 is connected to a base end portion of the contact part 6, and the contact part 6 protrudes downward from the peripheral part 7.

In the example shown in FIG. 1, the peripheral part 7 is configured as a retainer plate having a high rigidity. The peripheral part 7 (retainer plate) is formed in a plate shape, and maintains the plate shape. In the example shown in FIG. 1, the peripheral part 7 (retainer plate) is fixed to the case 2, but the peripheral part 7 may be a part of the case 2. The peripheral part 7 forms a base end portion. The base end portion maintains a predetermined shape and maintains its relative position and posture with respect to the case 2 unchanged, both in the contact state where the object W1 is in contact with the contact part 6 as shown in FIG. 1 and in the natural state where no object is in contact with the contact part 6 from the outside.

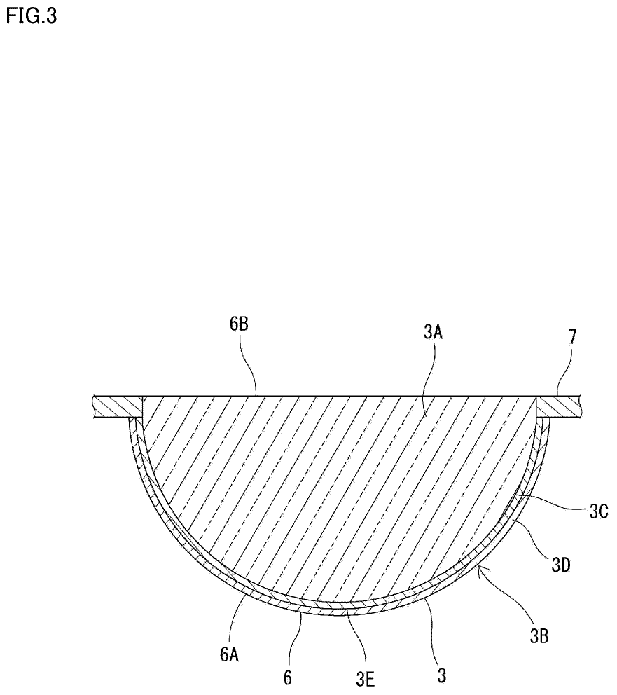

Specifically, the touch pad 3 can be configured as shown in FIG. 3. In the example shown in FIG. 3, the touch pad 3 includes a light transmitting member 3A and a filter 3B. The light transmitting member 3A is a member that allows light to pass therethrough, and, for example, a transparent member is used. In the example shown in FIG. 3, the light transmitting member 3A is made of a gel material having transparency, and is formed in a predetermined hemispherical shape. In a typical example shown in FIG. 3, the filter 3B includes a first layer 3C made of a white paint and a second layer 3D made of a black paint. The first layer 3C has a function of reflecting visible light and a function of transmitting infrared light. The first layer 3C is curved to be projected downward, and has a function of maintaining the shape of the light transmitting member 3A. The second layer 3D is a layer that allows light in the first wavelength range to pass therethrough and blocks light in a second wavelength range different from the first wavelength range, and is curved to be projected downward. The second layer 3D may be a layer of an applied paint as described above, or may be a layer of an adhered member, for example. In order to enhance the sensitivity, it is desirable that the filter 3B is thin and the hardness of the filter 3B is less than that of the light transmitting member 3A. The hemispherical contact part 6 composed of the light transmitting member 3A and the filter 3B is maintained in a predetermined shape when no object is in contact with the contact surface 6A and no pressing force is applied thereto. When an object comes into contact with the contact surface 6A and pressing force is applied to the contact surface 6A, the contact part 6 is deformed in response to the pressing force. When the pressing force is released, the contact part 6 returns to the predetermined shape.

The filter 3B is formed in a film shape. The contact part 6 has a contact surface 6A and a back surface 6B. The contact surface 6A is a surface, on one side of the contact part 6, which comes into contact with the object W1. The contact surface 6A is a surface that faces downward in the contact part 6, and is curved to be projected downward. In the typical example shown in FIG. 3, the contact surface 6A is an outer surface of the second layer 3D. The back surface 6B is a surface opposite to the contact surface 6A, and is a surface on the back side with respect to the contact surface 6A. The back surface 6B is a surface facing upward in the contact part 6. In the typical example shown in FIG. 3, the back surface 6B is an upper surface of the light transmitting member 3A.

The contact part 6 is configured such that deformation occurs near the marker 20 in response to the contact state of an object with the contact surface 6A. Factors that specify the contact state of the object W1 with the contact surface 6A include the shape of a part of the object W1 in contact with the contact surface 6A, the range in the contact surface 6A that receives contact from the object W1, and the magnitude and direction of force that the contact surface 6A receives at each of positions in the range.

In the state where no object is in contact with the contact surface 6A, the contact part 6 is maintained in a reference shape as shown in FIG. 3. In the state where the object W1 is in contact with the contact surface 6A as shown in FIG. 1 and FIG. 2, the contact part 6 is deformed in response to the contact state of the object W1 with the contact surface 6A. Thereafter, when the object W1 has been separated from the contact surface 6A and is no longer in contact with the contact surface 6A, the contact part 6 returns to the reference shape. The material forming the contact part 6 may be any material that provides the above function, and may be, for example, silicone rubber or other materials.

As shown in FIG. 4, the marker 20 is disposed on the contact part 6. In the example shown in FIG. 4, the marker 20 includes a plurality of marks 20A attached to the contact part 6, and is configured as a dot pattern by these marks 20A. The plurality of marks 20A forming the marker 20 are regularly arranged.

In the example shown in FIG. 4, each of the marks 20A forming the marker 20 has a circular shape. The shape of each mark 20A may be changed to a shape different from the circular shape as shown in FIG. 4. In this case, various shapes such as a polygon and an ellipse may be adopted. Although FIG. 4 shows the marker 20 configured as a dot pattern, the marker 20 shown in FIG. 4 is merely an example. The marker 20 may be changed to another dot pattern different from FIG. 4, or a grid pattern. When the marker 20 is a grid pattern, various patterns such as a lattice pattern, a triangular mesh pattern, and a hexagonal mesh pattern (honeycomb pattern) are adoptable.

When the marker 20 is a dot pattern in which the marks 20A as shown in FIG. 4 or marks different in shape from the marks 20A are arrayed, the marks constituting the dot pattern may be represented by paint, or may be represented by projections, or recesses. When the marker 20 is a grid pattern, the grid pattern may be represented by paint, or may be represented by projections or recesses. The marker 20 may be configured as a part different from the filter 3B and the light transmitting member 3A, or may be configured as a part of the filter 3B or a part of the light transmitting member 3A.

In the typical example of the present embodiment, each mark 20A shown in FIG. 4 is, for example, represented by paint applied to a lower surface 3E of the light transmitting member 3A in the contact part 6 shown in FIG. 3, and can be captured from the upper side of the light transmitting member 3A. Each mark 20A is covered with the filter 3B from the lower side, and is sandwiched between the light transmitting member 3A and the filter 3B. The marker 20 is irradiated with illumination light from the side opposite to the side where the object W1 comes into contact with the contact part 6, that is, from the upper side, and the marker 20 reflects light that is incident on the marker 20 from the opposite side. The imaging unit 4 can receive the reflected light from the marker 20, and can capture an image of a predetermined range including the marker 20 in the contact part 6. In the typical example, each mark 20A is sandwiched between the light transmitting member 3A and the first layer 3C such that each mark 20A which is black is disposed on the upper side of the first layer 3C which is white. Therefore, when the imaging unit 4 captures the predetermined range including the marker 20 from the upper side, an image in which the black marks 20A appear against the white first layer 3C as a background, is generated. In the typical example shown in FIG. 3, the black second layer 3D is disposed on the front side (lower side) while the white first layer 3C is disposed on the back side (upper side), but the present disclosure is not limited to this example, and the above arrangement may be reversed. That is, the black second layer 3D may be disposed on the back side (upper side) while the white first layer 3C is disposed on the front side (lower side). In this case, the marker 20 may be represented in a color (e.g., white) that can be distinguished from the second layer 3D. In any case, the marker 20 only needs to be located inside (on the imaging unit 4 side) relative to the second layer 3D.

The marker 20 is displaced in response to deformation of the contact part 6. Specifically, when the object W1 comes into contact with the contact surface 6A, the filter 3B and the marker 20, which form part of the contact part 6, are deformed from the reference shape in response to the contact state of the object W1, and, for example, the position, posture, and shape of each mark 20A disposed at the part deformed from the reference shape are changed.

For example, the contact part 6 configured as described above allows light in the first wavelength range to pass therethrough at a part or the entirety of the area other than the marker 20, and blocks light in the second wavelength range different from the first wavelength range. The first wavelength range includes, for example, at least a part of the wavelength range of infrared light or ultraviolet light, and the second wavelength range is, for example, the entirety of the wavelength range other than the first wavelength range. The second wavelength range preferably includes at least a part of the wavelength range of visible light.

In this specification, the wavelength range of visible light is greater than 400 nm and less than 760 nm. A range not less than 760 nm and not greater than 1000 nm is the range of infrared light. A range not less than 10 nm and not greater than 400 nm is the range of ultraviolet light. In the typical example, the first wavelength range is a range including at least a part of the wavelength range of infrared light. A lower limit value of the first wavelength range is preferably greater than a lower limit value of the wavelength range of infrared light. The lower limit value of the first wavelength range is preferably less than the center wavelength of the illumination light emitted from the irradiation unit 5. The center wavelength of the illumination light emitted from the irradiation unit 5 may be, for example, 850 nm or 940 nm. In this case, the lower limit value of the first wavelength range may be 800 nm, for example. Of course, the lower limit value may be a value other than this value. The first wavelength range may be the entire range not less than the lower limit value of the first wavelength range, and an upper limit value may be set. If an upper limit value of the first wavelength range is set, this upper limit value is preferably greater than the center wavelength of the illumination light emitted by the irradiation unit 5.
2. Shape Measurement System 10

The shape measurement system 10 shown in FIG. 2 is a system that uses the optical tactile sensor 1, and measures the shape of the object W1 by using an image generated by the optical tactile sensor 1. The shape measurement system 10 includes the optical tactile sensor 1, and a controller 11 that controls the entire shape measurement system 10.

The controller 11 includes a CPU 12 as an information processing unit, a ROM 13 and a RAM 14 as storage units, and an input/output port 15. The CPU 12 can perform various calculations and various controls. For example, the CPU 12 can execute various processes for controlling the entire shape measurement system 10, and can output the processing result as a predetermined control signal. ROM 13 stores various information including a control program for controlling the shape measurement system 10. Various kinds of information necessary for operating the shape measurement system 10 are temporarily stored in the RAM 14. The ROM 13 and the RAM 14 are merely examples, and other types of storage media may be used. The input/output port 15 is an interface used for communication, and the controller 11 can communicate with, for example, the imaging unit 4, and the irradiation unit 5 via the input/output port 15.

In the shape measurement system 10, the irradiation unit 5 emits illumination light and stops the emission, based on an instruction of the CPU 12. Furthermore, in the shape measurement system 10, the imaging unit 4 starts to capture an image of the marker 20, based on an instruction of the CPU 12, and the image generated through image capturing by the imaging unit 4 is given to the CPU 12.
3. Sensing Method and Shape Measurement Method

The shape measurement system 10 can execute a sensing method and a shape measurement method using the optical tactile sensor 1. When the shape measurement system 10 executes the sensing method, the CPU 12 performs a shape measurement control according to the program stored in advance in the storage unit, followed by an image capturing process and an analysis process. When the shape measurement system 10 executes the shape measurement method, a measurement process is further performed in addition to the image capturing process and the analysis process included in the sensing method.

For example, when a predetermined start condition has been satisfied, the CPU 12 executes the shape measurement control, followed by the image capturing process, the analysis process, and the measurement process. The start condition may be that a predetermined operation has been performed on an operation unit (not shown) provided in the shape measurement system 10, or that power supply to the controller 11 has been started, or may be other conditions.

When performing the shape measurement control in response to that the start condition has been satisfied, the CPU 12 firstly performs the image capturing process to cause the imaging unit 4 to perform image capturing. In the image capturing process, the CPU 12 gives instruction information that instructs irradiation, to the irradiation unit 5, and gives instruction information that instructs image capturing, to the imaging unit 4. Therefore, in the image capturing process, the imaging unit 4 captures an image of the marker 20 according to the instruction information while the irradiation unit 5 emits illumination light. The timing at which the imaging unit 4 generates an image in response to the information from the CPU 12 may be immediately after the CPU 12 has given the instruction information to the imaging unit 4, or each time at regular intervals after the CPU 12 has given the instruction information to the imaging unit 4, or may be another timing.

If the image capturing process is performed in the contact state where the object W1 is in contact with the contact surface 6A, the contact part 6 allows light in the first wavelength range to pass therethrough and blocks passage of light in the second wavelength range, and the marker 20 reflects light that is incident on the marker 20 from the upper side, whereby the imaging unit 4 can receive the reflected light from the marker 20 and the light in the first wavelength range, and generate an image of the marker 20 in the contact state. As long as the object W1 is present within the image capturing range during the image capturing by the imaging unit 4, regardless of whether the object W1 is in the contact state or the non-contact state, the light in the first wavelength range emitted from the irradiation unit 5 passes through the contact part 6 and is applied to the object W1, and the reflected light from the object W1 due to the irradiation passes through the contact part 6 and is received by the imaging unit 4. Therefore, in the image capturing process, when the object W1 is in the contact state, the imaging unit 4 can generate an image by capturing the marker 20 and the object W1 from the upper side, and, even when the object W1 is in the non-contact state, the imaging unit 4 can generate an image by capturing the marker 20 and the object W1 from the upper side.

Then, the CPU 12 analyzes the captured image obtained by the sensing method, whereby, for example, the shape of the object W1 can be measured. Specifically, the CPU 12 acquires the captured image by executing the aforementioned image capturing process, and thereafter performs the analysis process. In the analysis process, the CPU 12 extracts the image of the marker 20 and the image of the object W1 from the captured image generated in the image capturing process. In performing the analysis process, the CPU 12 may extract the image of the marker 20 and the image of the object W1 from the image generated by the imaging unit 4, by using the entirety of the image information generated by the imaging unit 4.

The analysis process may include a process of generating an image in which influence of “a part of light” is reduced or removed from the image information generated by the imaging unit 4. The analysis process also includes a process of extracting the image of the marker 20 and the image of the object W1 from the image which is reduced or removed influence of “the part of light”. In this case, the CPU 12 corresponds to an example of an image generation unit. In the case where the influence of “the part of light” is reduced or removed in the analysis process, “the part of light” may be light in a predetermined wavelength range other than the first wavelength range, or light in a predetermined wavelength range within the first wavelength range. For example, in the case where “the part of light” is the “light in the predetermined wavelength range other than the first wavelength range”, if an image in which the influence of “the part of light” is reduced or removed is generated, an image in which the light in the first wavelength range is relatively emphasized can be generated. For example, in the analysis process, the CPU 12 may remove, from the image information generated by the imaging unit 4, image information of G components generated by a plurality of G elements and image information of B components generated by a plurality of B elements of the imaging unit 4, and may extract the image of the marker 20 and the image of the object W1 from an image utilizing only image information of R components generated by a plurality of R elements. In this example, if the plurality of R elements are capable of receiving light in a wavelength range including at least a part of the first wavelength range and the plurality of G elements and the plurality of B elements are incapable of receiving the light in the first wavelength range, it is possible to remove the “light in the predetermined wavelength range other than then first wavelength range”. Alternatively, in the case where the density of each of the RGB components is expressed in 256 gradations in each of pixels included in the captured image generated by the imaging unit 4, the densities of the G component and the B component in each pixel may be set to 0 or may be significantly reduced, or the image information generated by the imaging unit 4 may be subjected to another filtering process to generate an image in which the light in the predetermined wavelength range other than the first wavelength range is reduced or removed.

As another example of the analysis process, a process in which “the part of light” is the “light in the first wavelength range” may be included. By generating an image in which the influence of “the part of light” is reduced or removed, an image in which light outside the first wavelength range is relatively emphasized can be generated. For example, in the analysis process, the CPU 12 may remove the image information of the R components from the image information generated by the imaging unit 4, and extract the image of the marker 20 from the image utilizing only the image information of the G components and the image information of the B components. In this example, if the plurality of R elements are capable of receiving light in a wavelength range including at least a part of the first wavelength range and the plurality of G elements and the plurality of B elements are incapable of receiving the light in the first wavelength range, it is possible to remove the “light in the first wavelength range”, and an image similar to that obtained when the contact part 6 blocks external light can be obtained. In the case where the density of each of the RGB components is expressed in 256 gradations in each of pixels included in the captured image generated by the imaging unit 4, the density of the R component in each pixel may be set to 0 or may be significantly reduced, or the image information generated by the imaging unit 4 may be subjected to another filtering process to generate an image in which the light in the first wavelength range is reduced or removed.

In the measurement process, the shape of the object W1 is obtained based on the image generated in the analysis process. Specifically, in the measurement process, the image generated by the imaging unit 4 is analyzed to obtain the shape of the object W1. Various known methods can be adopted as a method for detecting the shape of the object W1 that is in contact with the contact part on which the marker is attached, from the captured image of the marker configured as, for example, a dot pattern or a grid pattern. The methods disclosed in references such as JP 2005-257343 A, WO 2005/085785 A1, and JP 2005-114715 A may be adopted, or other well-known methods may be adopted. For example, the CPU 12 may analyze the image information obtained in the aforementioned image capturing process, and measure the size of the contact area where the object W1 is in contact with the contact part 6, and the deformed shape after the contact, or measure the magnitude and direction of force applied by the object W1 to each of positions in the contact part 6. The controller 11 corresponds to an example of a shape measurement unit, and has a function of analyzing the image generated by the imaging unit 4, and measuring the shape of the object W1. Furthermore, the CPU 12 can also measure, for example, the external shape, size, and position of the object W1 from an image obtained by directly capturing the object W1, based on light being transmitted through the contact part 6.
4. Examples of Effects

In the optical tactile sensor 1, when the object W1 comes into contact with the contact surface 6A, the contact part 6 is deformed in response to the contact state of the object W1, and the marker 20 is changed in response to the deformation of the contact part 6. This configuration allows the imaging unit 4 to capture an image of the “marker 20 in which the contact state of the object W1 is reflected”. When the imaging unit 4 generates an image of the marker 20, the image can be generated while the light in the second wavelength range is reliably prevented from entering the imaging unit 4 through a space on the object W1 side. Moreover, when the object W1 is present within the image capturing range, the imaging unit 4 can also generate an image of the object W1, based on the light in the first wavelength range that passes through the contact part 6 from the space on the object W1 side.

The aforementioned sensing method using the optical tactile sensor 1 and the robot hand and robot arm equipped with the optical tactile sensor 1 also achieve the above effects. The shape measurement method and the shape measurement system 10 using the optical tactile sensor 1 can measure the shape of the object W1 while achieving the above effects by using the optical tactile sensor 1.

In the optical tactile sensor 1, when the imaging unit 4 receives reflected light from the marker 20 and captures an image of the marker 20, the imaging unit can perform the image capturing while blocking the light in the second wavelength range from the space on the object W1 side. Therefore, in generating the image of the marker 20, the light in the second wavelength range, which enters the contact part 6 from the space on the object W1 side, is reliably prevented from affecting the image. For example, in the case where the light in the second wavelength range enters the imaging unit 4 from the space on the object W1 side and thereby such disturbance light causes the image of the marker 20 to have the same color as the image of its surroundings, there is a risk that the outer edge of the marker 20 is not accurately shown. However, the optical tactile sensor 1 can solve this problem.

On the other hand, in the optical tactile sensor 1, the contact part 6 allows the light in the first wavelength range to pass therethrough, and the imaging unit 4 can receive the light in the first wavelength range to generate an image. That is, by generating an image based on the light in the first wavelength range when the object W1 comes close to the contact surface 6A, the imaging unit 4 can generate the image in which the object W1 is shown more clearly, even if the contact part 6 is interposed between the object W1 and the imaging unit 4. For example, even if the object W1 is not in contact with the contact part 6 and the contact part 6 is not deformed, the imaging unit 4 can obtain the image of the object W1 as a transmission image based on light having been transmitted through the contact part 6. Moreover, since the light in the second wavelength range, which enters the contact part 6 from the space on the object W1 side, is blocked by the contact part 6, influence of disturbance light in the second wavelength range is reduced in generating the transmission image of the object W1.

In the aforementioned typical example, the first wavelength range includes a wavelength range of at least a part of the wavelength range of infrared light. The optical tactile sensor 1 is more effective when visible light in the second wavelength range is strong in the space on the object W1 side and infrared light included in the first wavelength range is not so strong. In such a case, it is possible to prevent the overly strong visible light in the second wavelength range in the space on the object W1 side from adversely affecting capturing of the image of the marker 20, and it is possible to capture an image of the object W1 with the transmitted light in the first wavelength range.

In the optical tactile sensor 1, the light in the first wavelength range, which is included in the illumination light emitted from the irradiation unit 5, passes through the contact part 6, enters the object W1, and is reflected by the object W1. Then, the light in the first wavelength range, of the reflected light, passes through the contact part 6 and is received by the imaging unit 4. That is, in the optical tactile sensor 1, even when the contact part 6 is interposed between the irradiation unit 5 and the object W1 or between the imaging unit 4 and the object W1, the imaging unit 4 can capture an image of the object W1 more clearly while irradiating the object W1 with the light in the first wavelength range included in the illumination light.

In the case where the irradiation unit 5 is an infrared irradiation device as in the optical tactile sensor 1 of the typical example, not only irradiation of the object W with the illumination light but also heating of the object W with the infrared light can be achieved. In this case, the irradiation unit 5 functions as a heater that heats the object W. Moreover, the contact part 6 may be formed of “temperature indication rubber whose color changes with temperature”. In this case, the temperature of the contact part 6 can be measured by capturing an image of the contact part 6 with the imaging unit 4, and analyzing the obtained image of the contact part 6 to evaluate the color.

### Second Embodiment

An optical tactile sensor 1 according to the second embodiment is different from the optical tactile sensor 1 of the first embodiment only in the specific configuration of the irradiation unit 5, the material of the filter 3B, and the analysis method for image information generated by the imaging unit 4, and is otherwise identical to the first embodiment. Since the configurations shown in FIG. 1 to FIG. 4 are common between the first embodiment and the second embodiment, description of the optical tactile sensor 1 according to the second embodiment also refers to FIG. 1 to FIG. 4.

In the second embodiment, the first wavelength range includes at least a part of the wavelength range of ultraviolet light, and the second wavelength range is, for example, the entire wavelength range other than the first wavelength range. The second wavelength range preferably includes at least a part of the wavelength range of visible light.

In the second embodiment, an upper limit value of the first wavelength range is preferably smaller than an upper limit value of the wavelength range of ultraviolet light. The upper limit value of the first wavelength range is preferably a value greater than the center wavelength of illumination light emitted by the irradiation unit 5. The illumination light emitted by the irradiation unit 5 is light including ultraviolet light. The first wavelength range may be the entire range not greater than the upper limit value of the first wavelength range, and a lower limit value may be set. When a lower limit value of the first wavelength range is set, this lower limit value is preferably smaller than the center wavelength of the illumination light emitted by the irradiation unit 5. In the specific example of the second embodiment, as the irradiation unit 5, a unit that emits visible light and a unit that emits light in the wavelength range of ultraviolet light are separately provided. However, the irradiation unit 5 is not limited to this example, and may be a single illumination device capable of emitting both visible light and ultraviolet light.

As shown in FIG. 4, the contact part 6 of the optical tactile sensor 1 according to the second embodiment also has the contact surface 6A that comes into contact with the object W1, and is deformed in response to the contact state of the object W1 with the contact surface 6A. The marker 20 is disposed on the contact part 6, and is displaced in response to deformation of the contact part 6. The imaging unit 4 captures an image of the marker 20 from the side opposite to the side where the object W1 comes into contact, and the marker 20 reflects light that is incident on the marker 20 from the opposite side. The imaging unit 4 functions to generate an image upon receiving the reflected light from the marker 20 and the light in the first wavelength range. The contact part 6 allows the light in the first wavelength range to pass therethrough, and blocks light in the second wavelength range different from the first wavelength range.

The shape measurement system 10 according to the second embodiment performs the image capturing process, the analysis process, and the measurement process by using the optical tactile sensor 1 of the second embodiment, in the same manner as the shape measurement system 10 according to the first embodiment. The analysis process is basically the same as that in the first embodiment, but may be changed in accordance with that the first wavelength range includes the wavelength range of ultraviolet light.

In this embodiment as well, in the analysis process, the CPU 12 extracts an image of the marker 20 and an image of the object W1 from the captured image generated in the image capturing process. In performing the analysis process, the CPU 12 may extract the image of the marker 20 and the image of the object W1 from the image generated by the imaging unit 4, by using the entirety of the image information generated by the imaging unit 4.

The analysis process may include a process of generating an image in which influence of “a part of light” is reduced or removed from the image information generated by the imaging unit 4, and extracting, from this image, the image of the marker 20 and the image of the object W1. For example, in the analysis process, the CPU 12 may remove, from the image information generated by the imaging unit 4, the image information of the R components and the image information of the G components of the imaging unit 4, and may extract, from the image utilizing only the image information of the B components, the image of the marker 20 and the image of the object W1. In this example, if the plurality of B elements are capable of receiving light in the wavelength range including at least a part of the first wavelength range and the plurality of R elements and the plurality of G elements are incapable of receiving the light in the first wavelength range, it is possible to remove the “light in the predetermined wavelength range other than the first wavelength range”. Alternatively, in the case where the density of each of RGB components is expressed in 256 gradations in each of pixels included in the captured image generated by the imaging unit 4, the densities of the R component and the G component in each pixel may be set to 0 or may be significantly reduced, or the image information generated by the imaging unit 4 may be subjected to another filtering process to generate an image in which the light in the predetermined wavelength range other than the first wavelength range is reduced or removed.

As another example of the analysis process, a process in which “the part of light” is the “light in the first wavelength range” may be included. For example, in the analysis process, the CPU 12 may remove the image information of the B components from the image information generated by the imaging unit 4, and extract the image of the marker 20 from the image utilizing only the image information of the R components and the image information of the G components. In this example, if the plurality of B elements are capable of receiving light in a wavelength range including at least a part of the first wavelength range and the plurality of R elements and the plurality of G elements are capable of receiving the light in the first wavelength range, it is possible to remove the “light in the first wavelength range”, and an image similar to that obtained when the contact part 6 blocks external light can be obtained. In the case where the density of each of the RGB components is expressed in 256 gradations in each of pixels included in the captured image generated by the imaging unit 4, the density of the B component in each pixel may be set to 0 or may be significantly reduced, or the image information generated by the imaging unit 4 may be subjected to another filtering process to generate an image in which the light in the first wavelength range is reduced or removed.

The optical tactile sensor 1 of the second embodiment is more effective when visible light in the second wavelength range is strong in the space on the object W1 side and the light in the first wavelength range is not so strong. In such a case, it is possible to prevent the overly strong visible light in the second wavelength range in the space on the object W1 side from adversely affecting capturing of the image of the marker 20, and it is possible to capture an image of the object W1 with the transmitted light in the first wavelength range including ultraviolet light. Moreover, the optical tactile sensor 1 can capture an image of the object W1 while sterilizing the object W1 by irradiating the object W1 with ultraviolet light, and therefore is extremely effective in, for example, an environment where it is desired to sterilize the object W1 and grasp the shape of the object at the same time.

In the optical tactile sensor 1 of the second embodiment, the imaging unit 4 may receive light only in the visible light region to generate a captured image, may receive lights in the visible light region and the infrared light region to generate a captured image, or may receive lights in the visible light region and the ultraviolet light region to generate a captured image.

For example, when ultraviolet light is used for purposes such as sterilization, an imaging device that receives light in the visible light region to generate a captured image and does not reflect ultraviolet light, may be used as the imaging unit 4. Meanwhile, as the irradiation unit 5, an illumination device in which a light source that emits ultraviolet light (e.g., ultraviolet LED) and a light source that emits visible light (e.g., visible light LED) are separately configured, may be used. In this example, the object W1 can be sterilized when the irradiation unit 5 irradiates the object W1 with ultraviolet light while the object W1 is located near the contact part 6. Meanwhile, the imaging unit 4 can generate a captured image including an image of the marker 20 by receiving visible light including reflected light from the vicinity of the marker 20.

Alternatively, in the optical tactile sensor 1 of the second embodiment, the imaging unit 4 may receive lights in the visible light region and the ultraviolet light region to generate a captured image. In this case as well, as the irradiation unit 5, an illumination device in which a light source that emits ultraviolet light (e.g., ultraviolet LED) and a light source that emits visible light (e.g., visible light LED) are separately configured, may be used. In either example, the irradiation unit 5 is not limited to an illumination device in which a light source that emits ultraviolet light and a light source that emits visible light are separately configured, and an illumination device including a single light source that can emit lights in the visible light region and the ultraviolet light region may be adopted.

### Third Embodiment

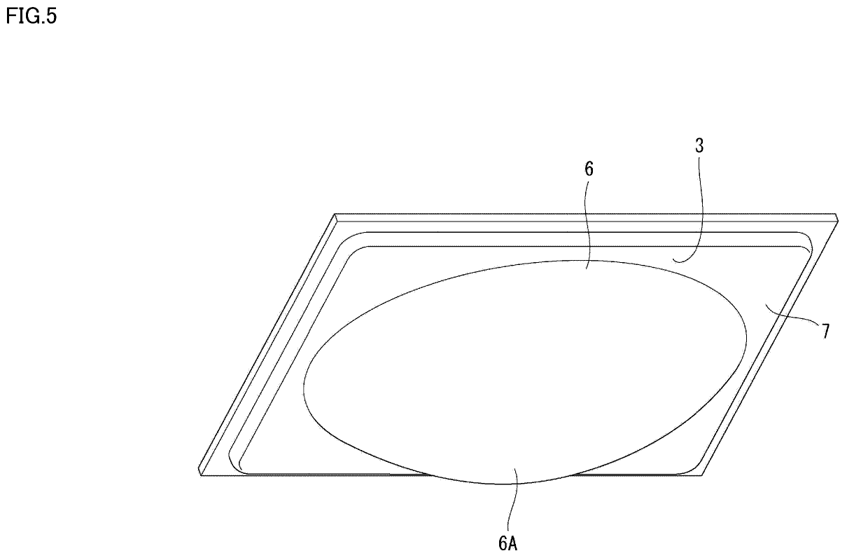

An optical tactile sensor 1 according to the third embodiment is different from the optical tactile sensor 1 of the first embodiment in that the touch pad 3 shown in FIG. 3 is modified as shown in FIG. 5, and is otherwise identical to the first embodiment. Since the configurations shown in FIG. 1 and FIG. 2 are common between the first embodiment and the third embodiment, description of the optical tactile sensor 1 according to the third embodiment also refers to FIG. 1 and FIG. 2.

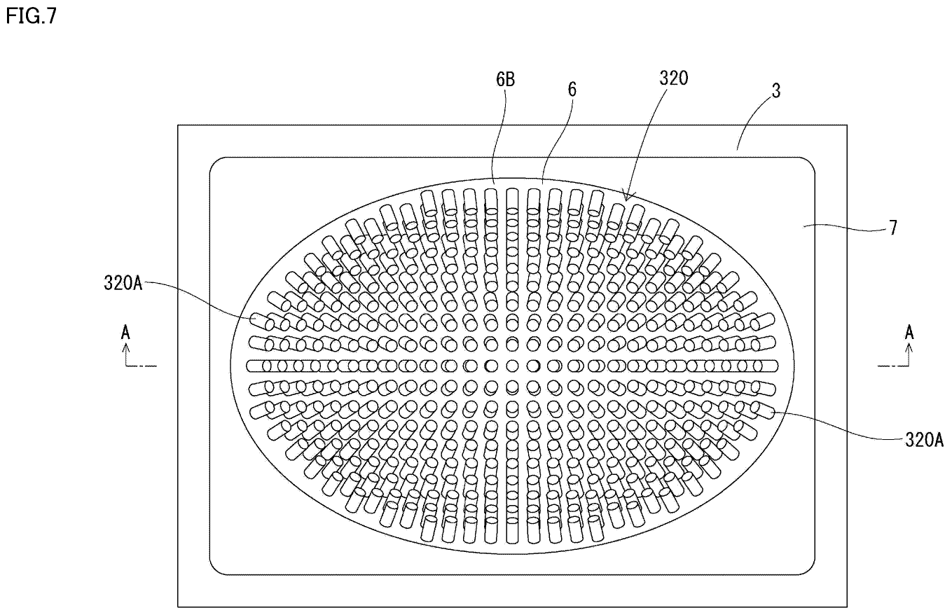

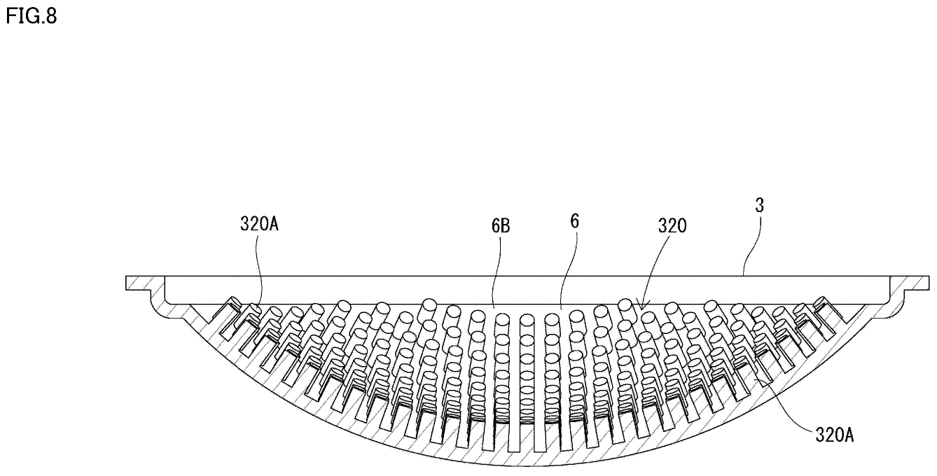

The optical tactile sensor 1 of the third embodiment also includes members such as a case 2, an imaging unit 4, and an irradiation unit 5, which are the same as those of the first embodiment, as shown in FIG. 1. However, a touch pad 3 having the configuration as shown in FIG. 5 to FIG. 8 instead of the configuration shown in FIG. 3 and FIG. 4, is used. A shape measurement system 10 using the optical tactile sensor 1 of the third embodiment has the same configuration as shown in FIG. 2, and includes the same controller 11 as that of the first embodiment.

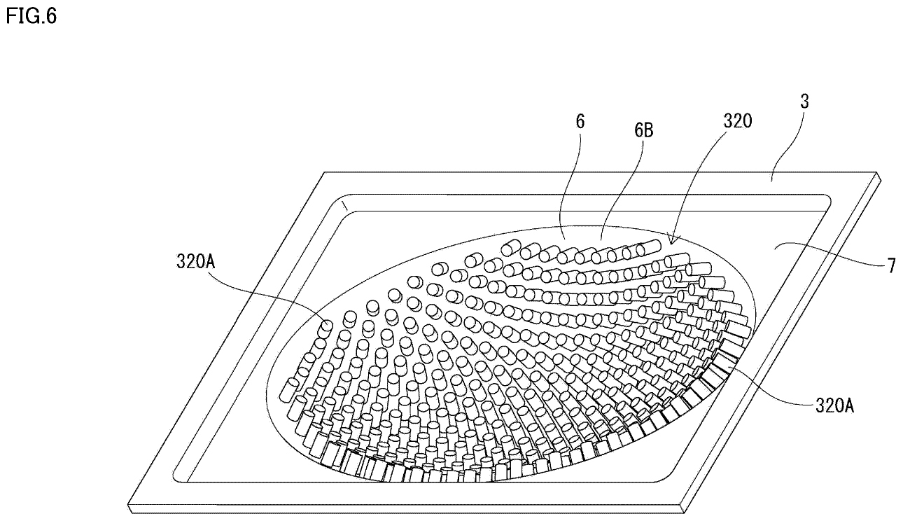

In the optical tactile sensor 1 of the third embodiment as well, the irradiation unit 5 is configured to irradiate a marker 320 shown in FIG. 6 with illumination light from the side opposite to the side where the object W1 comes into contact. The imaging unit 4 captures an image of the marker 320 from the side opposite to the side where the object W1 comes into contact.

As shown in FIG. 1, FIG. 2, and FIG. 5, the contact part 6 of the optical tactile sensor 1 of the third embodiment also includes a contact surface 6A that has a film shape and comes into contact with the object W1. The contact part 6 is deformed in response to the contact state of the object W1 with the contact surface 6A. In the configuration shown in FIG. 5 as well, the contact part 6 has the same configuration as that shown in FIG. 3, in which a filter similar to the filter 3B overlaps a light transmitting member similar to the light transmitting member 3A in FIG. 3. Although the retainer plate 8 is omitted in FIG. 5 to FIG. 8, a retainer plate 8 similar to that of the first embodiment may or may not be provided.

The contact surface 6A is a surface, on one side of the contact part 6, which comes into contact with the object W1. The contact surface 6A is a surface that faces downward in the contact part 6, and is curved to be projected downward. In other words, the contact surface 6A is a curved surface projecting to the side where the object W1 comes into contact. The back surface 6B is a surface opposite to the contact surface 6A, and is a surface on the back side with respect to the contact surface 6A. The back surface 6B is a surface that faces upward in the contact part 6, and that is curved to be recessed downward as viewed from the space inside the case 2 shown in FIG. 1.

As shown in FIG. 6 to FIG. 8, the contact part 6 is provided with the marker 320. The marker 320 is a part that is displaced in response to deformation of the contact part 6. The marker 320 has a plurality of projections 320A that project from the back surface 6B of the film-shaped contact part 6. The plurality of projections 320A project upward from the back surface 6B. Each of the projections 320A projects in the normal direction from the back surface 6B. Specifically, the plurality of projection 320A projects in the normal direction with respect to the direction of the contact surface 6A and the back surface 6B at the position of the base end of the projection 320A.

In the shape measurement system 10 using the optical tactile sensor 1 of the third embodiment, an image capturing process, an analysis process, and a measurement process can be performed in the same manner as in the first embodiment. As a precondition for the measurement process, information on the shape of the contact part 6 and information on the shape of the marker 320 are stored in the controller 11. Specifically, the information, for example, the positions and shapes of the contact surface 6A and the back surface 6B of the contact part 6, the thickness of the contact part 6 at each position, and the position, length, thickness, direction of each of the projections 320A is stored in the controller 11. Therefore, the CPU 12 analyzes the image information obtained in the image capturing process, and extracts and specifies the images of the respective projections 320A, whereby, based on these images, the CPU 12 can measure the size of the contact area where the object W1 is in contact with the contact part 6, and the deformed shape of the contact area after the contact, and moreover, can measure the magnitude and direction of the force applied by the object W1 to the contact part 6 at each position. In this example, the controller 11 corresponds to an example of a shape measurement unit, and functions to analyze the image generated by the imaging unit 4 and measure the shape of the object W1. Furthermore, the CPU 12 can also measure, for example, the external shape, size, and position of the object W1 from the image obtained by directly capturing the object W1, based on the light transmitted through the contact part 6.

In the optical tactile sensor 1 of the third embodiment, since the projections 320A project from the back surface 6B of the contact part 6, if there is a change in position or posture of the contact part 6 near a projection 320A, the position and posture of this projection 320A is changed in response to the change. Therefore, when the imaging unit 4 captures the marker 320, the imaging unit 4 can generate an image in which the position and posture of each portion of the contact part 6 are expressed by the position and posture of each projection 320A. Moreover, in this optical tactile sensor 1, when inclination of the contact part 6 changes near a projection 320A, the tip of the projection 320A is displaced more significantly, and the change in the inclination of the contact part 6 is more clearly expressed in the image.

For example, in the case where a marker is drawn on a part of the back surface of the contact part, if inclination of the contact part slightly changes near the marker, inclination of the marker itself also changes slightly. Even if an image of such a marker is captured, a difference from the marker before the change is small, and the change in the inclination of the contact part cannot be accurately detected from the image. Meanwhile, in the optical tactile sensor 1 of the third embodiment, even if change in the posture of a projection 320A near the base end is a “minor change in inclination”, the tip of the projection 320A is likely to be displaced more significantly while amplifying the change. Therefore, in the image obtained by capturing the marker 320, the change in the inclination of the projection 320A near the base end is likely to be clearly expressed as a “displacement on the tip of the projection 320A”.

Specifically, each projection 320A can be formed so as to be aligned with the normal direction of the corresponding position, whereby a plurality of projections 320A can be efficiently arranged in the space near the back surface 6B. Since the shape measurement system 10 can perform image analysis on the premise that each projection 320A projects in the normal direction, the shape measurement system 10 is advantageous in performing analysis to grasp the state of the contact part 6 near each projection, compared to a configuration in which the projections project in different directions.

The contact surface 6A is a curved surface that protrudes toward the side where the object W1 comes into contact, and therefore is easily applicable to an object W1 suitable for such a curved surface, and a change due to the contact of the object W1 is easily visible in the marker 20.

Each projection 320A may have the same color as a whole, or the color of a part of a projection 320A may be different from the color of the other part of the projection 320A. At the tip of each projection 320A, a tip marker different in at least one of hue, brightness, and saturation from the back surface 6B may be disposed. For example, the color of the tip surface of each projection 320A shown in FIG. 6 to FIG. 8 may be made different from the color of the back surface 6B. In this case, when the imaging unit 4 analyzes the image obtained by capturing the marker 320, the image of the tip surface of each projection 320A is clearly distinguished from the image of the back surface 6B, whereby the image of the tip surface can be reliably extracted. In this case, the portion at the tip surface corresponds to an example of the tip marker. When each projection 320A is provided with the tip marker as described above, an intermediate portion, which is different in at least one of hue, brightness, and saturation from the tip marker and the back surface 6B, may be disposed between the tip marker and the back surface 6B. For example, the color of the tip surface of each projection 320A is made different from the color of the back surface 6B, and the color of a portion, other than the tip surface, of the projection 320A is made different from the colors of the tip surface and the back surface 6B. In this case, when the imaging unit 4 analyzes the image obtained by capturing the marker 320, the image of the tip surface of the projection 320A, the image of the intermediate portion, other than the tip surface, of the projection 320A, and the image of the back surface 6B can be clearly distinguished from each other.

### Fourth Embodiment

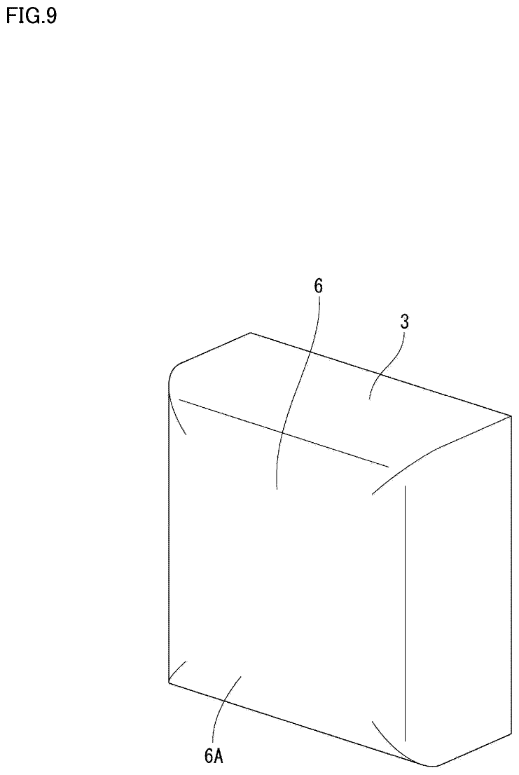

An optical tactile sensor 1 according to the fourth embodiment is different from the optical tactile sensor 1 of the first embodiment in that the touch pad 3 shown in FIG. 3 is modified as shown in FIG. 9, and is otherwise identical to the first embodiment. Since the configurations shown in FIG. 1 and FIG. 2 are common between the first embodiment and the fourth embodiment, description of the optical tactile sensor 1 according to the fourth embodiment also refers to FIG. 1 and FIG. 2. However, in FIG. 1 and FIG. 2, the shape of the touch pad 3 is changed to the shape as shown in FIG. 9.

The optical tactile sensor 1 of the fourth embodiment also includes members such as a case 2, an imaging unit 4, and an irradiation unit 5, which are the same as those of the first embodiment, as shown in FIG. 1. However, a touch pad 3 having the configuration as shown in FIG. 9 to FIG. 12 instead of the configuration shown in FIG. 3 and FIG. 4, is used. A shape measurement system 10 using the optical tactile sensor 1 of the fourth embodiment has the same configuration as that shown in FIG. 2, and includes the same controller 11 as that of the first embodiment.

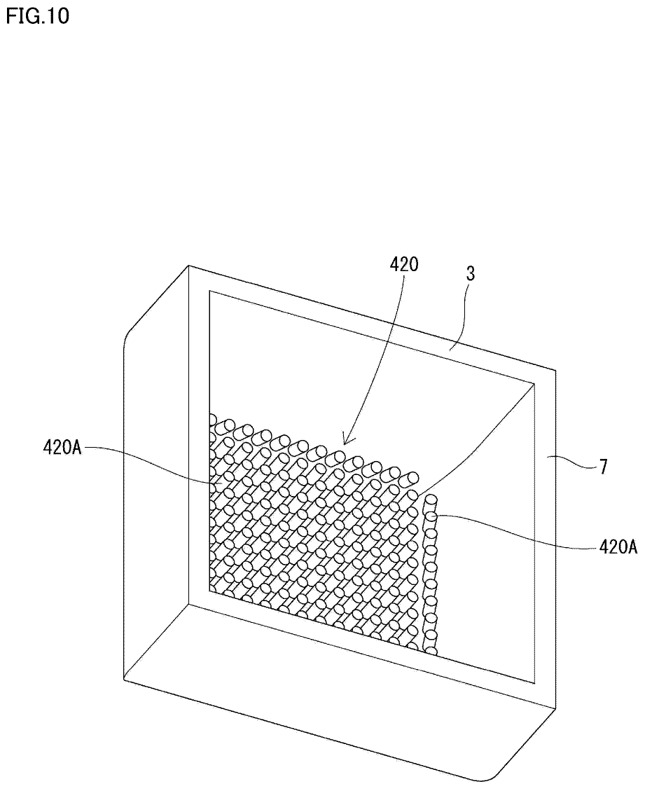

In the optical tactile sensor 1 of the fourth embodiment as well, the irradiation unit 5 is configured to irradiate a marker 420 shown in FIG. 10 to FIG. 12 with illumination light from the side opposite to the side where the object W1 comes into contact. The imaging unit 4 captures an image of the marker 420 from the side opposite to the side where the object W1 comes into contact.

As shown in FIG. 9, the contact part 6 of the optical tactile sensor 1 of the fourth embodiment also includes a contact surface 6A that has a film shape and comes into contact with the object W1. The contact part 6 is deformed in response to the contact state of the object W1 with the contact surface 6A. In the configuration shown in FIG. 9 as well, the contact part 6 has the same configuration as that shown in FIG. 3, in which a filter similar to the filter 3B overlaps a light transmitting member similar to the light transmitting member 3A in FIG. 3.

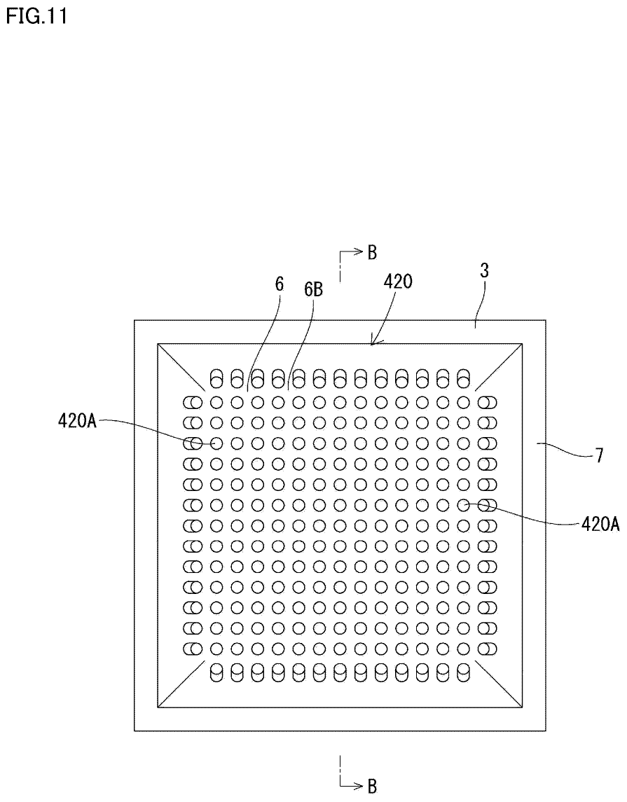

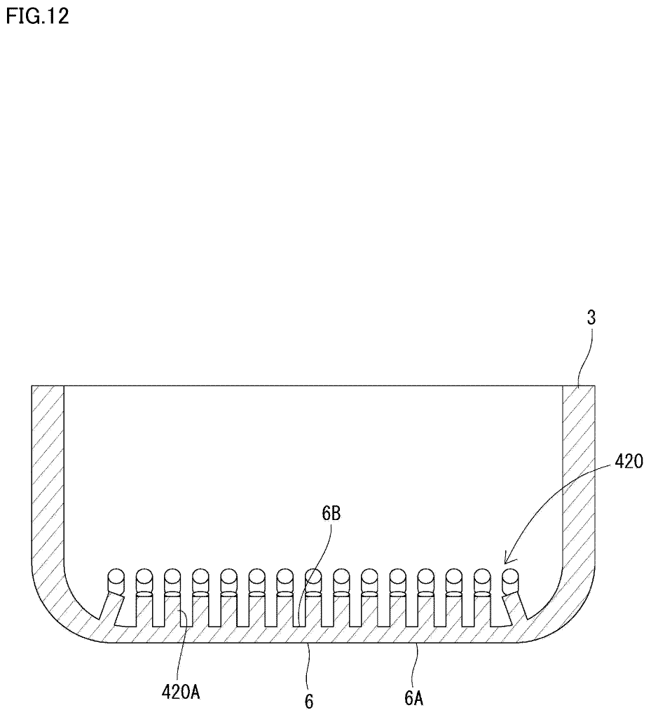

The contact surface 6A is a surface, on one side of the contact part 6, which comes into contact with the object W1. The contact surface 6A is a surface that faces downward in the contact part 6, and most of its area is a flat surface in the horizontal direction perpendicular to the up-down direction. As shown in FIG. 11 and FIG. 12, the back surface 6B is a surface opposite to the contact surface 6A, and is a surface on the back side with respect to the contact surface 6A. The back surface 6B is a surface that faces upward in the contact part 6, and most of its area is a flat surface in the direction perpendicular to the up-down direction.

As shown in FIG. 10 to FIG. 12, the contact part 6 is provided with a marker 420. The marker 420 is a part that is displaced in response to deformation of the contact part 6. The marker 420 has a plurality of projections 420A that project from the back surface 6B of the film-shaped contact part 6. The plurality of projections 420A project upward from the back surface 6B. Specifically, each of the projections 420A projects in the normal direction from the back surface 6B. Specifically, the plurality of projections 420A projects in the normal direction with respect to the direction of the contact surface 6A and the back surface 6B at the position of the base end of the projection 420A. In the example shown in FIG. 11 and FIG. 12, a part of the back surface 6B is a flat surface in the horizontal direction, and the projections 420A disposed on this flat surface project in the imaging direction of the imaging unit 4. The projections 420A disposed on the flat surface project upward in the direction along the up-down direction.

In the shape measurement system 10 using the optical tactile sensor 1 of the fourth embodiment, an image capturing process, an analysis process, and a measurement process can be performed in the same manner as in the third embodiment.

### Other Embodiments

The present disclosure is not limited to the embodiments described above and illustrated in the drawings, and for example, the following embodiments are also within the technical scope of the present disclosure.

In the third and fourth embodiments, the contact part 6 allows light in the first wavelength range to pass through, and blocks passage of light in the second wavelength range different from the first wavelength range. However, the present disclosure is not limited to this example. The contact part 6 may be a light-shielding film that blocks passage of light, or may be a light-transmitting film that allows, for example, visible light to pass through.

In the aforementioned embodiments, the irradiation unit 5, which emits

illumination light including light in the first wavelength range, irradiates the contact part 6 with illumination light from the upper side (inside). Instead of or in addition to this configuration, an irradiation unit similar to the irradiation unit 5 may be provided so as to irradiate the contact part 6 with illumination light from the lower side (outside).

In the aforementioned embodiments, the irradiation unit 5 emits illumination light including light in the first wavelength range. However, the irradiation unit 5 may emit only visible light. In this case, it is preferable that illumination light including light in the first wavelength range (sunlight or illumination light from an external device) is applied to the contact part 6 from outside the contact part 6.

In the aforementioned embodiments, the filter 3B is composed of the first layer 3C and the second layer 3D, but the filter 3B may be composed of only the second layer 3D. In this case, the second layer 3D preferably has a thickness that can maintain the shape of the light transmitting member 3A. In this case, since the marker 20 is interposed between the second layer 3D of black paint and the light transmitting member 3A, the marker 20 may have a color (e.g., white) different from the second layer 3D.

In the aforementioned embodiments, the entire light transmitting member 3A is formed of gel, but a space may be formed inside the light transmitting member 3A such that air exists instead of the gel in a certain area. In this case, it is preferable that the light transmitting member 3A existing around this space has elasticity and viscosity.

This disclosure is not limited to the embodiments detailed above, and various modifications and variations are possible.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. An optical tactile sensor comprising:
a contact part having a contact surface that comes into contact with an object, the contact part being deformed in response to a contact state of the object with respect to the contact surface;
a marker disposed on the contact part, and configured to be displaced in response to deformation of the contact part; and
an imaging unit configured to capture an image of the marker from an opposite side that is a side opposite to a side where the object comes into contact, wherein
the contact part allows light in a first wavelength range to pass therethrough, and blocks light in a second wavelength range different from the first wavelength range,
the marker reflects light that is incident on the marker from the opposite side, and
the imaging unit receives the light reflected by the marker and the light in the first wavelength range, and generates an image.

2. The optical tactile sensor according to claim 1, wherein
the first wavelength range includes at least a portion of a wavelength range of infrared light or ultraviolet light, and
the second wavelength range includes at least a portion of a wavelength range of visible light.

3. The optical tactile sensor according to claim 1, comprising an irradiation unit configured to irradiate the contact part with illumination light including the light of the first wavelength range from the opposite side.

4. The optical tactile sensor according to claim 1, comprising an image generation unit configured to generate an image in which influence of a part of light is reduced or removed, based on image information generated by the imaging unit.

5. The optical tactile sensor according to claim 1, wherein
the contact part has a film shape, and
the marker includes a plurality of projections that project from a back surface, of the contact part, opposite to the contact surface.

6. A robot hand including the optical tactile sensor according to claim 1.

7. A robot arm including the optical tactile sensor according to claim 1.
